(19) United States
(12) Patent Application Publication
(10) Pub. No.: US 2006/0175111 A1
(43) Pub. Date: Aug. 10, 2006

(54) Tractive appliance or driven means of locomotion

(76) Inventors: Stephan Soder, Zumikon (CH); Felix Peter, Sargans (CH)

Correspondence Address: NOTARO AND MICHALOS, 100 DUTCH HILL ROAD, SUITE 110, ORANGEBURG, NY, 10962-2100, US

(21) Appl. No.: 10/532,860

(22) PCT Filed: Nov. 4, 2003
(86) PCT No.: PCT/CH03/00722

§ 371 Date: Aug. 1, 2005

(30) Foreign Application Priority Data
Nov. 5, 2002 (CH) 1852/02

(51) Int. Cl. B62K 11/00

(52) U.S. Cl. 180/220

(57) ABSTRACT

The invention relates to a device for displacing a person situated on a mobile or drivable base. Said device comprises a holding, steering, or guiding rod (3) comprising steering and holding handles (5) which the person can hold on to. The inventive device also comprises a carrying wheel (7) which is located at the opposite end to the holding handles (5) on the rod (3). The device is driven by an electric motor (11) arranged inside the carrying wheel. A drivable base (35) is arranged on or in the device in such a way that it can be removed, in order to optionally receive the person moving with said device.

The present invention relates to a device for the locomotion of a person according to the preamble of claim 1 as well as to means of locomotion with a device and a training apparatus or a learning aid with a device.

Simple means of locomotion, such as skate boards, roller skates, inline skates, roller blades, scooters and the like are increasingly gaining enormous popularity. However, the introduction to apparatus such as skate boards, roller skates, inline skates and the like is not always simple and the listed means of locomotion require, moreover, good physical condition as well as good balance. Even in the case of scooters the locomotion takes place by the user's own muscular force: Added to this is the fact that the circle of persons utilizing said means of locomotion enjoys a certain excitement and likes continuous [technical] advance and has a positive approach to new capabilities in the use of said sports equipment.

One object of the present invention is therefore providing a reasonable supplement to cover said manifold requirements.

A further object is providing a self-driven means of locomotion, which makes possible as rapid, uncomplicated and simple a locomotion as is possible.

Expressed differently, one object of the present invention is providing a multifunctional apparatus, which makes possible the locomotion of persons utilizing roller blades, skate boards, inline skates as well as also the locomotion per se, i.e. an apparatus which makes possible the locomotion without the use of said means of locomotion, such as roller skates, skate boards and the like.

The defined object is attained by means of a device according to the wording of claim 1.

Proposed is a device for the locomotion of a person, the person being located on a movable or drivable platform, which device is characterized thereby that it comprises a handlebar-steering rod with steering-holding grips, onto which the person can hold, at least one running wheel, which is located in the region at the opposite end with respect to the holding grips on the holding rod, as well as an electric motor in order to drive the running wheel for the locomotion of the person.

A preferred embodiment variant proposes that the running wheel has a hub-free drive. The drive is preferably disposed in the interior of the running wheel preferably spring-elastically pivoted with respect to the wheel. The advantage of this spring-elastic disposition lies therein that a significantly quieter running can be attained in comparison to the rigid disposition of the drive with respect to the wheel.

According to a preferred embodiment variant driving means, such as for example gear wheels or cylinders are provided, which under spring prestress are driven onto the inner circumferential surface of the wheel, and the driving is, for example, transmitted via frictional adhesion or by providing a toothing.

Again a further preferred embodiment variant proposes providing a drivable platform, which is disposed on or in the device such that it is removable again in order to accommodate a person for the locomotion with the device. This platform is connected with the device via a connection element, such as a cord, a cable, a chain, a bar and the like. It further comprises at least one, preferably two or more wheel roller cylinders or crawler-like elements. Again according to a preferred embodiment variant, the drivable platform comprises at least one plate-shaped element. When utilizing two plate-shaped elements, it is possible to connect these with one another such that they can be folded toward and away from one another, and in the folded open state is disposed preferably laterally on each outside a locomotion element, such as a wheel, and the person to be transported has the capability of utilizing the plate-shaped elements as a drivable platform.

Therewith a person does not absolutely have to rely for the locomotion by means of the device according to the invention on utilizing sports equipment or a drivable apparatus, such as a skate board, roller skates, inline skates, roller blades and the like, but the locomotion is also possible without the use of such an apparatus by utilizing the drivable platforms connected with the device. However, it is also possible to utilize the device according to the invention without said drivable platform.

The device proposed according to the invention permits a person the locomotion without exerting any physical effort thereby that the locomotion is made possible by driving the device. Therewith, on the one hand, the utilization of said sports equipment is also made possible for persons who do not have a corresponding physical constitution and, on the other hand, also for persons who do not want to do without the use of said sports equipment. In addition, the holding rod provides an additional hold such that in particular for beginners the utilization of said sports equipment or of the drivable platform removed from the device is simplified. In particular in the case of inline skates, roller blades, roller skates and the like or also when using the drivable platform connected with the device, through the device according to the invention an additional standing leg is provided, and since the locomotion does not need to be accomplished by the person himself, consequently in simple manner a sense of motion can be gained, wherewith in particular the introduction to said sports equipment can be significantly simplified.

However, even only the rapid locomotion is made possible in particular through the use of the drivable platform connected with the device, wherewith per se an entirely novel sports apparatus can be provided.

However, this device is not limited to employment as sports equipment, but can be viewed as a simple, handy and maneuverable means of locomotion which demands minimal space and which, in particular in urban areas, can be highly useful for locomotion.

By disposing said electric motor around the running wheel, the apparatus is moreover quiet, environmentally friendly and free of exhaust gas.

The transmission of the driving preferably takes place via driving gears or cylinders pivoted under spring prestress against the wheel.

Depending on the type and size of the utilized battery, the operating length of the device can be selected. An additional electronic control permits different regulations of the motor and therewith of the driving member, such as for example the selection of speed, of acceleration, of braking, etc. Further necessary is the application of brakes, such as mechanical brakes, in order to make rapid stopping of the device possible. Since the device according to the invention pulls the user behind it, the weight of the person during braking acts additionally onto the device such that a short brake path results.

A current regeneration means is preferably provided, whereby during braking or downhill moving current can be regenerated.

Further preferred embodiment variants of the device according to the invention are characterized in the dependent claims.

The inventive device is suitable for example as a tractive appliance for persons utilizing said sports equipment, as a training apparatus, as learning aid, as means of locomotion per se, etc.

In the following the invention will be explained in further detail by example and with reference to the enclosed figures. Therein depict:

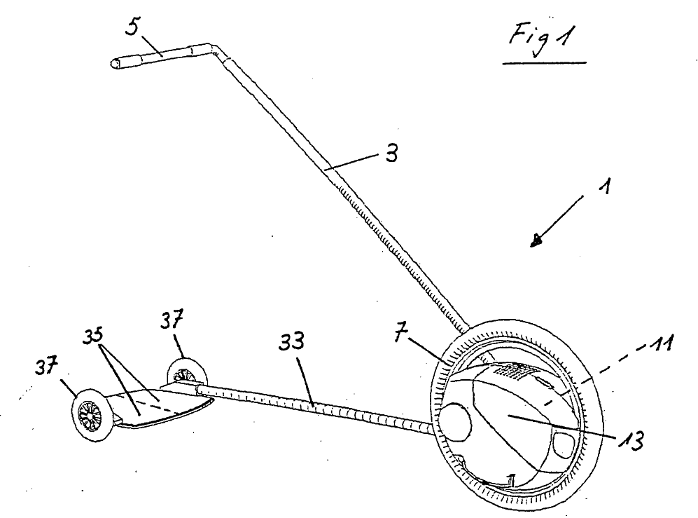

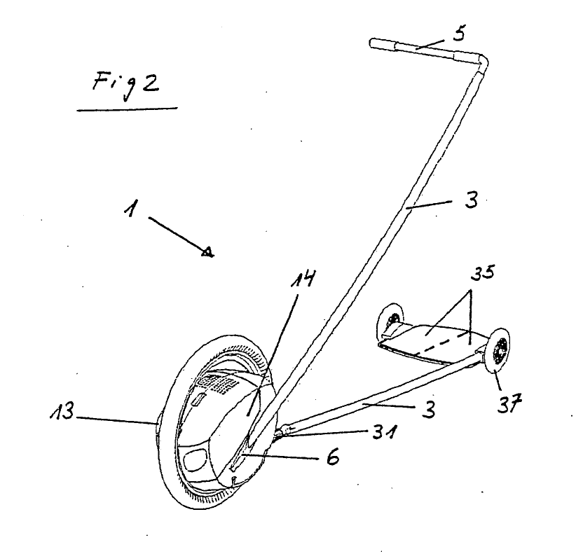

FIG. 1 a perspective view of the device according to the invention,

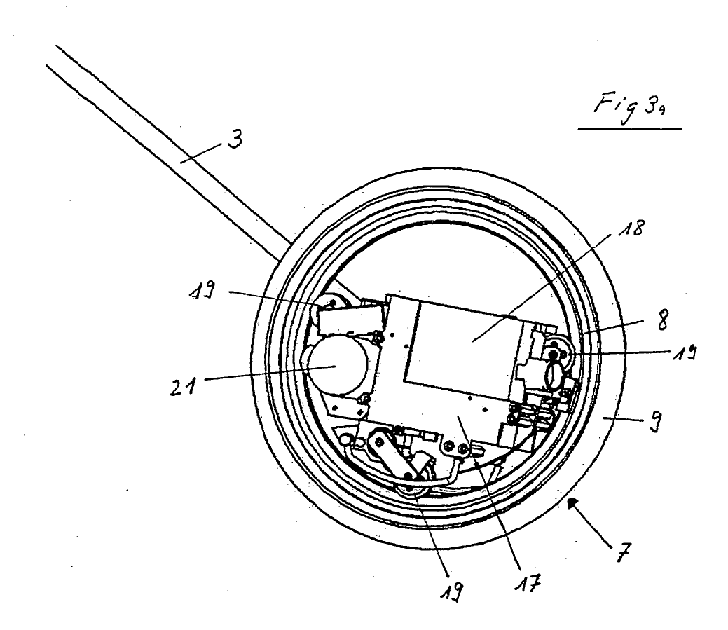

FIG. 2 a further perspective view of the device according to the invention,

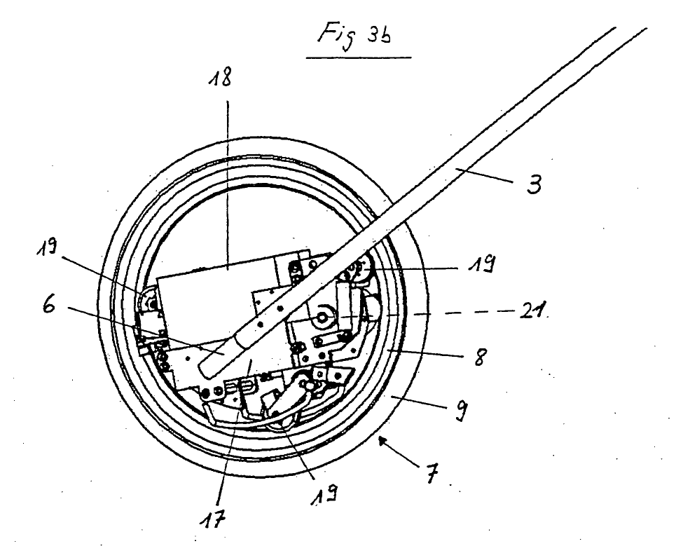

FIGS. 3a and 3b the drive in perspective seen from both sides of the running wheel,

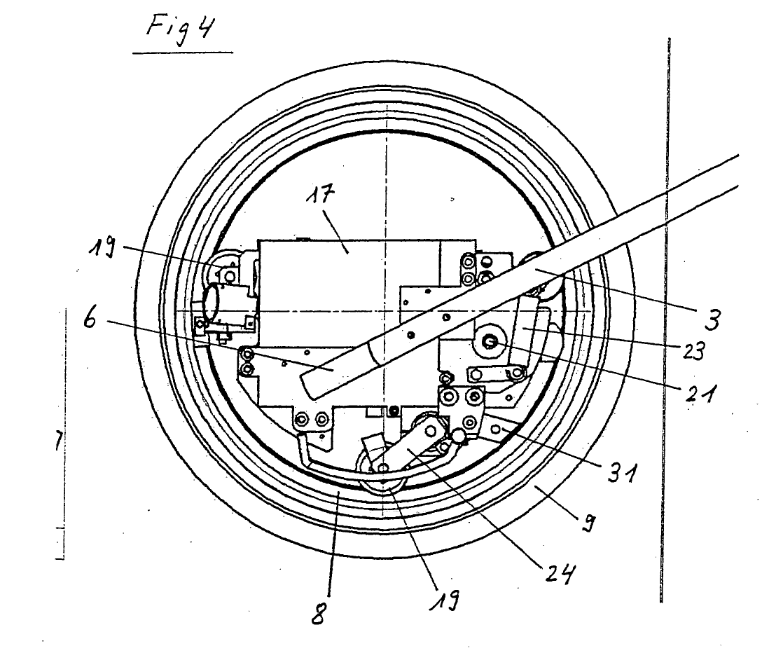

FIG. 4 sectionally the drive disposed in the interior of the running wheel, and

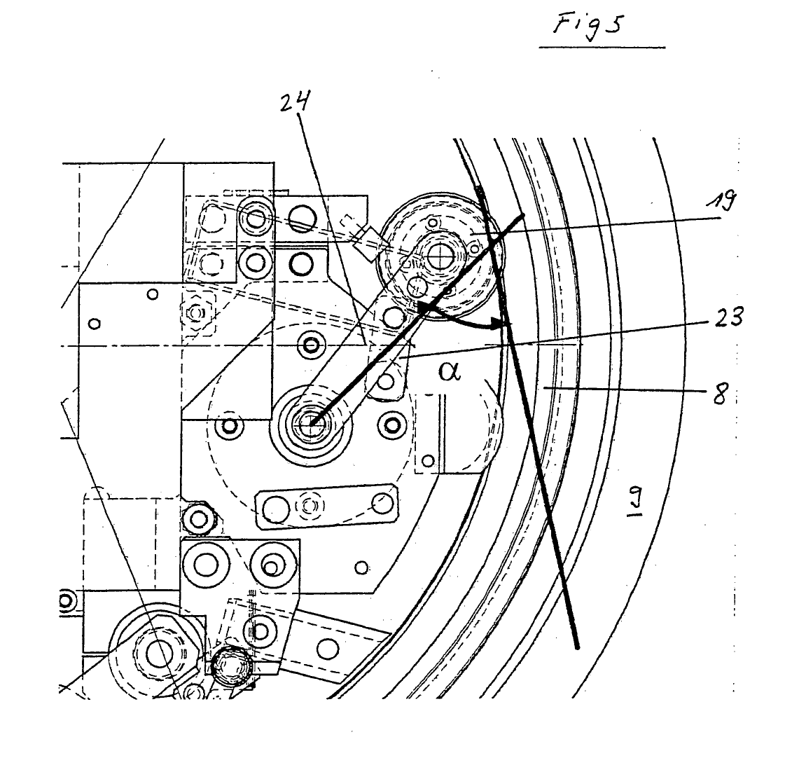

FIG. 5 enlarged detail from FIG. 4, the disposition of the driving mechanism with rocker arm, friction wheel, guide component, representing the angular conditions of driving roller, driving rocker arm and rim.

FIG. 1 depicts in perspective a device 1 according to the invention comprising a holding, steering or guiding rod 3, on which at the upper terminal end steering-holding grips 5 are disposed, onto which a person to be transported can hold. At the opposite end of the steering rod 3 is disposed a running wheel 7, in whose interior cavity a drive 11 is disposed under a cover hood 13.

On an adapter fitting (not visible) is further disposed a connecting element or a holding rod 33, which is connected for example via a releasably pluggable, or threadable, snap-engagable connection with the cover hood 13 or the running wheel 7. At the end of this holding rod 33 two, preferably foldable, plate-like elements 35 are disposed, on the outside of each of which two running rollers 37 are disposed which support the plate-shaped elements 35.

FIG. 2 shows the same device 1 according to the invention from the other side, again in perspective view. Clearly evident in FIG. 2 is the connection of the holding, steering or guiding rod 3 on the outer cover hood or casing 14. For the connection of the steering rod 3 with the cover hood 14 is also provided an adapting or mounting element 6, as well as an adapter fitting 31 for the connection element 33.

FIGS. 3a and 3b show in perspective the drive 11 viewed from both sides of the running wheel with the two cover hoods 13 and 14 omitted.

The running wheel 7 itself is preferably comprised of a rubber tire disposed on the outside of a rim 8 either with or without an air tube. On the inside of the rim 8 are provided three running or driving rollers 19 spring prestressed onto the inner circumferential surface, via which rollers the driving is transmitted for example from an electric motor 21 onto the rim. The transmission can take place either through frictional adhesion or by providing a toothing. The drive 11 itself is comprised of said electric motor 21, an electronic control 18 as well as at least one battery 17, preferably two or more batteries.

Lastly, in FIG. 4 the drive 11 is shown in section and not enlarged in the interior of the running wheel 7, with further details being evident in FIG. 5. In particular, the driving gears 19 are clearly evident, which, for example via a spring element, such as a spring bushing 23, are driven under prestress against the inner circumferential surface of the rim 8. The driving can take place either via frictional adhesion, thereby that for example the gears 19 are fabricated of rubber or an elastomeric polymer material, such as for example polyurethane, a silicon material or another suitable elastomer. It has furthermore been found to be advantageous if the holding arms 24 are disposed angled off with respect to the inner surface of rim 8, the included angle preferably being of the order of magnitude of approximately 30-50 degrees.

However, it is also possible to provide a perforation in relation to toothed gear on the inner circumference of rim 8, wherewith the driving gears 19 are preferably implemented as toothed gears.

Further evident is the spring arrangement or spring bushing 23, by means of which the arm 24 or the gear 19 is driven under spring prestress against the inner surface of rim 8. The connecting adapters 6 and 31 are again shown in FIG. 4, to which adapters, on the one hand, the steering rod 3 and, for example, an additional drivable platform, as shown in FIGS. 1 and 2, can be connected.

FIG. 5, lastly, shows as a detail from FIG. 4 an enlargement of the driving unit in the proximity of a driving gear 19 and elucidates the geometric disposition of the driving components. FIG. 5 is intended to make clear that for the pressing of the driving gear 19 onto the inside of rim 8 a preferred angle is selected which is formed, on the one hand, by the holding arm 24, on which the driving gear 19 is pivoted and, on the other hand, the tangent in that region at which the driving gear is driven onto the rim. The spring prestress through the driving gear 19 is accomplished by a spring bushing 23.

It has been found that said included angle α is simply preferably of the order of magnitude of approximately 45-65 degrees, and specifically preferable driving values for an angle between 50 and 60 degrees result.

The inventive device described with reference to FIGS. 1 to 5 can, on the one hand, be utilized for locomotion by a person utilizing sports equipment, such as roller blades, roller skates, a skate board, inline skates and the like, as well as also by a person who is not using sports equipment of the described type. By connecting additionally or optionally the inventive, drivable platform, the latter person has the capability of locomotion analogously to those persons who utilize sports equipment of the described type.

Expressed differently, the device depicted in FIGS. 1 to 5 involves a multifunctional apparatus, which is suitable for the most diverse application purposes.

It is understood that the illustrations in FIGS. 1 to 5 are only examples, which are suitable to explain the present invention in greater detail. It is, of course, possible to modify the depicted apparatus in any desired manner or to supplement it by further elements. In particular the manner of driving and the utilization of a running wheel is not a primary subject of the present invention and the materials utilized for the device are also not a subject of the present invention.

It is fundamentally essential that the device of the type according to the invention is suited to make possible the locomotion for a person utilizing sports equipment largely without applying any muscular force and also allowing the locomotion in similar manner for a person not utilizing corresponding sports equipment.

1. Device for the locomotion of a person, the person being located on a movable or drivable platform, characterized by
a holding, steering or guiding rod (3) with steering-holding grips, onto which the person can hold,
at least one running wheel (7), located in the region at the opposite end of the holding grips on the rod,
an electric motor (11) to drive the running wheel (7) for the locomotion of the person, and optionally
a drivable platform (35) which is disposed on or in the device such that it is removable again, in order to accommodate a person for the locomotion with the device.

2. Device as claimed in claim 1, characterized in that the drive (11) is disposed in the interior of the running wheel (7) pivoted spring elastically with respect to the running wheel.

3. Device as claimed in claim 1, characterized in that at least one, preferably three or more driving means, such as gear wheels or cylinders (19) are provided for the force transmission from the drive or electric motor (11) onto the inner surface of the wheel circumference of the running wheel (7).

4. Device as claimed in claim 3, characterized in that the driving gears or cylinders (19) are disposed under spring prestress onto the inner surface of the running wheel (7), such that the driving takes place through frictional adhesion and/or by tooth intermeshing.

5. Device as claimed in claim 4, characterized in that one each of the arms or bolts (24) supporting the driving gears or cylinders (19) forms with the running wheel an angle (α) of the order of magnitude of approximately 45 to 65 degrees, preferably an angle of 50 to 60 degrees.

6. Device as claimed in claim 1, characterized in that a drivable platform (35) is provided, which is connectable with the running wheel such that it can be removed again, in order to accommodate a person for the locomotion with the device.

7. Device as claimed in claim 6, characterized in that the platform (35) is connected with the running wheel (7) via a connection element (33), such as a cord, a cable, a chain, a bar and the like.

8. Device as claimed in claim 6, characterized in that the platform (35) comprises at least one, preferably two or more wheel-, roller-, cylinder- or crawler-like elements (37).

9. Device as claimed claim 6, characterized in that the drivable platform (35) comprises at least one plate-shaped element, optionally preferably two plate-shaped elements, in the case of at least two elements these being connected with one another such that they can be folded toward or away from one another, and the element, or the at least two elements in the folded open state, each comprising laterally on the outside an element of locomotion, such as for example a wheel (37).

10. Device as claimed claim 1, characterized in that the holding, steering or guiding rod (3) is implemented such that its length can be varied in the manner of telescope and/or to be foldable or swivelable about a hinge centrally and/or in the region at the opposite end.

11. Device as claimed in claim 1, characterized in that further elements are provided, such as illumination, signal senders, mounting for mobile telephone, radio, CD, minidisk players including amplifier, key compartment, bottle holders and the like.

12. Device as claimed claim 1, characterized in that further a fuel cell is provided for generating the electric current for driving the electric motor.

13. Means of locomotion with a device as claimed in claim 1.

14. Training apparatus or learning aid with a device as claimed in claim 1.
